(19) United States
(12) Patent Application Publication
(10) Pub. No.: US 2020/0198659 A1
(43) Pub. Date: Jun. 25, 2020

(54) VEHICLE CONTROL DEVICE

(71) Applicant: ISUZU MOTORS LIMITED, Shinagawa-ku, Tokyo (JP)

(72) Inventors: Tatsuya OOSHIMA, Saitama-shi, Saitama (JP); Junpei MATSUDA, Yokohama-shi, Kanagawa (JP)

(21) Appl. No.: 16/613,058

(22) PCT Filed: May 10, 2018
(86) PCT No.: PCT/JP2018/018070

§ 371 Date: Nov. 12, 2019

(30) Foreign Application Priority Data
May 12, 2017 (JP) 2017-095971

(51) Int. Cl. B60W 60/00; B60L 15/20; F16H 61/475

(52) U.S. Cl. CPC B60W 60/0018; B60W 60/0011; F16H 61/475; B60L 15/2081; B60W 60/0025

(57) ABSTRACT

A vehicle control device including: a road gradient acquisition unit configured to acquire a road gradient of a road on which a vehicle is currently traveling; a travel section determination unit configured to determine a forward travel section that is a travel section having a different road gradient from a current travel section in which the vehicle is currently traveling and that is ahead in a travel direction of the vehicle; and a horsepower limitation unit configured to limit an output horsepower of an engine based on a travel resistance of the vehicle, in which the horsepower limitation unit is configured to release the output horsepower limitation of the engine in a case where the travel resistance in the forward travel section is greater than the travel resistance of the vehicle in the current travel section.

### TECHNICAL FIELD

The present disclosure relates to a vehicle control device for controlling a vehicle.

### BACKGROUND ART

As a technique for controlling acceleration of a vehicle, there has been a travel control device that performs horsepower limitation control of an engine based on a travel resistance horsepower, which is a power required for the vehicle to travel at a constant speed (see, for example, Patent Literature 1).

### CITATION LIST

### Patent Literature

Patent Literature 1: JP-A-2017-20481

### SUMMARY OF INVENTION

### Technical Problem

The travel control device disclosed in Patent Literature 1 releases horsepower limitation of the engine in a case where the travel resistance horsepower required by the vehicle increases. For this reason, for example, in a case where the vehicle enters an uphill road or the like on which the required travel resistance horsepower increases, if it takes time until the output horsepower limitation is released and a marginal horsepower of the vehicle decreases, a driver may feel uncomfortable.

The present disclosure is made in view of the above circumstances, and an object thereof is to provide a vehicle control device capable of reducing an uncomfortable feeling of a driver.

### Solution to Problem

The vehicle control device of the present disclosure includes: a road gradient acquisition unit configured to acquire a road gradient of a road on which a vehicle is currently traveling; a travel section determination unit configured to determine a forward travel section that is a travel section having a different road gradient from a current travel section in which the vehicle is traveling and that is ahead in a travel direction of the vehicle; and a horsepower limitation unit configured to perform an output horsepower limitation that limits an output horsepower of an engine based on a travel resistance of the vehicle, and the horsepower limitation unit is configured to release the output horsepower limitation of the engine in a case where the travel resistance in the forward travel section is greater than the travel resistance of the vehicle in the current travel section.

The horsepower limitation unit may be configured to releases the output horsepower limitation of the engine based on the travel resistance of the vehicle estimated using the road gradient of the forward travel section.

The vehicle control device may further include: a current gear stage selection unit configured to select a current gear stage, which is a gear stage in the current travel section, based on the travel resistance; a forward gear stage selection unit configured to select a forward gear stage, which is a gear stage of the vehicle in the forward travel section; and a shift control unit configured to control shift so as to prevent upshift and to maintain the current gear stage in a case where the current gear stage selection unit newly selects a target gear stage higher than the forward gear stage while the vehicle is traveling in the current travel section at the current gear stage, and the horsepower limitation unit may be configured to release the output horsepower limitation of the engine in a state where the shift control unit is preventing the upshift of the gear stage.

The shift control unit may be configured to perform downshift from the current gear stage to the selected forward gear stage in a case where the forward gear stage is lower by two or more stages than the current gear state, and the horsepower limitation unit may be configured to release the output horsepower limitation of the engine in a case where the shift control unit controls shift so as to perform the downshift to the forward gear stage lower by two or more stages than the current gear state.

For example, the horsepower limitation unit is configured to release the output horsepower limitation of the engine in a case where the vehicle enters a predetermined range including a border between the current travel section and the forward travel section.

### Advantageous Effects of Invention

According to the present disclosure, it is possible to reduce an uncomfortable feeling of a driver.

### BRIEF DESCRIPTION OF DRAWINGS

FIG. 1 is a diagram for explaining an outline of a vehicle according to an embodiment.

FIG. 2 is a diagram schematically showing an internal configuration of the vehicle according to the embodiment.

FIG. 3 is a diagram schematically showing a functional configuration of the vehicle control device according to the embodiment.

FIG. 4 is a flowchart of a processing of releasing limitation of an output horsepower of an engine in a state in which upshift is prevented.

FIG. 5 is a flowchart of a processing of releasing output limitation of an engine in a case where downshift is performed.

### DESCRIPTION OF EMBODIMENTS

<Outline of Embodiment>

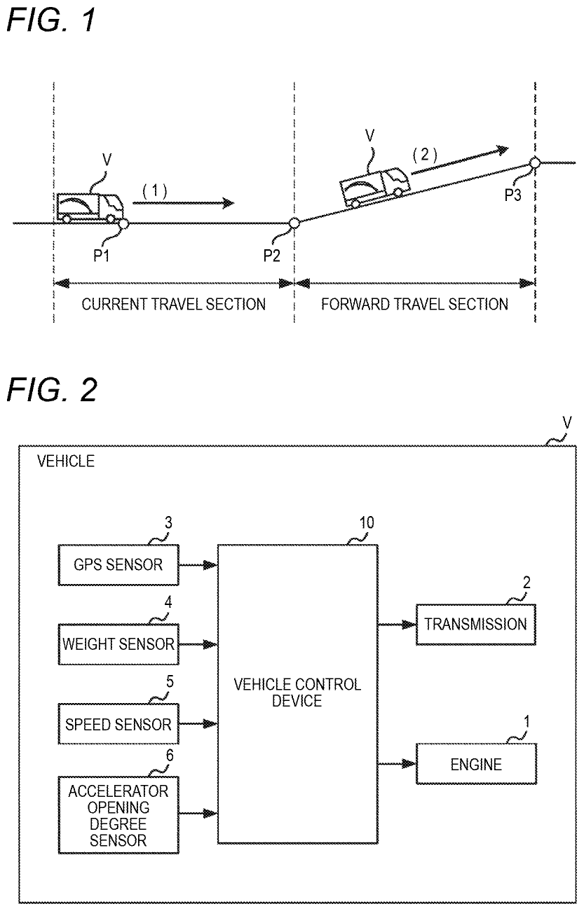

FIG. 1 is a diagram for explaining an outline of a vehicle V according to an embodiment. The outline of the vehicle V according to the embodiment will be described with reference to FIG. 1. The vehicle V according to the embodiment is a large vehicle that uses an engine such as a diesel engine as a driving force.

In recent years, in order to improve fuel efficiency of a vehicle, an arithmetic device such as an electronic control unit (ECU) mounted as a vehicle control device on a vehicle has been widely used to limit output of an engine of the vehicle so that the vehicle does not accelerate unnecessarily. The ECU limits an output horsepower of the engine based on a travel resistance horsepower estimated during travel. The travel resistance horsepower is a power required for the vehicle V to travel at a constant speed, and is a power required to maintain a current speed.

In a case where the required travel resistance horsepower increases, the vehicle V increases the output horsepower of the engine so as to be capable of traveling with a certain marginal horsepower. However, in a case where the required travel resistance horsepower rapidly increases with respect to a maximum output horsepower of the engine that is limited by the ECU, the marginal horsepower decreases. In this way, in a case where the ECU limits the output horsepower of the engine based on the travel resistance horsepower estimated during travel, release of the output horsepower limitation of the engine may be delayed, and the marginal horsepower of the vehicle may decrease.

Therefore, the vehicle V according to the embodiment has a satellite navigation function of acquiring position information indicating a current position of the vehicle V based on information received from a navigation satellite. The vehicle V stores gradient information of a road on which the vehicle V travels. The vehicle V may include an autonomous navigation function of acquiring the current position of the vehicle V based on an output value of an acceleration sensor or the like without using information received from a navigation satellite.

The ECU of the vehicle V foresees the gradient information of the road on which the vehicle V will travel in the near future based on the gradient information of the road and the position information of the vehicle V. In FIG. 1, the vehicle V is traveling in a “current travel section” having a location A as a start point and a location B as an end point. In the example shown in FIG. 1, the road on which the vehicle V is traveling has an ascending gradient of equal to or greater than a certain value in a “forward travel section” having the location B as a start point and a location C as an end point. The “forward travel section” is a travel section in which the road gradient is different from the current travel section in which the vehicle V is currently traveling, and is a travel section ahead of the vehicle V in a traveling direction.

The ECU of the vehicle V can calculate the travel resistance horsepower required in the forward travel section before the travel resistance horsepower required during travel increases by foreseeing the gradient information of the forward travel section. Then, the vehicle V according to the embodiment releases limitation of the output horsepower of the engine in a case where the vehicle V enters the forward travel section that is an ascending gradient. As a result, the vehicle V according to the embodiment can prevent decrease in the marginal horsepower of the vehicle even in the case where the vehicle V enters the forward travel section that is an ascending gradient.

<Vehicle Configuration According to an Embodiment>

An internal configuration of the vehicle V according to the embodiment will be described with reference to FIG. 2. FIG. 2 is a diagram schematically showing an internal configuration of the vehicle V according to the embodiment. The vehicle V according to the embodiment includes an engine 1, a transmission 2, a global positioning system (GPS) sensor 3, a weight sensor 4, a speed sensor 5, an accelerator opening degree sensor 6, and the vehicle control device 10 as the ECU.

The vehicle V is a large vehicle that uses the engine 1 such as a diesel engine as a driving force, and is, in particular, a vehicle that is mounted with an automatic cruise mode. The transmission 2 transmits a rotational driving force of the engine 1 to a drive wheel (not shown) of the vehicle V. The transmission 2 includes a plurality of stages of gears for converting the rotational driving force of the engine 1. In the present embodiment, the transmission 2 is assumed to include first to twelfth forward gear stages and a reverse gear stage.

Here, the “automatic cruise mode” in the vehicle V refers to a mode in which the engine 1, the transmission 2, and the like are automatically controlled by the ECU so as to maintain a vehicle speed of the vehicle V set in advance even if the driver does not operate an accelerator or a shift lever. The automatic cruise mode is mainly assumed to be used when the vehicle V travels on a highway. When the vehicle V cruises on a highway with a small gradient, selection of the gear of the transmission 2 at the twelfth or the eleventh stage leads to increase in the fuel efficiency of the vehicle V in many cases.

The GPS sensor 3 receives and analyzes radio waves transmitted from a plurality of navigation satellites so as to acquire a position of the GPS sensor 3, that is, a position of the vehicle V on which the GPS sensor 3 is mounted. The GPS sensor 3 outputs information indicating the position of the vehicle V to the vehicle control device 10.

The weight sensor 4 acquires a total weight of the vehicle V. Specifically, the weight sensor 4 measures a weight of load on the vehicle V, and sums the measured weight with a weight of the vehicle V alone excluding the load so as to acquire the total weight of the vehicle V. The weight sensor 4 outputs information indicating the total weight of the vehicle V to the vehicle control device 10.

The speed sensor 5 measures the vehicle speed of the vehicle V. The speed sensor 5 outputs information indicating the measured vehicle speed to the vehicle control device 10. The accelerator opening degree sensor 6 measures an accelerator opening degree which is a depression amount of an accelerator pedal by the driver of the vehicle V. The accelerator opening degree sensor 6 outputs information indicating the accelerator opening degree to the vehicle control device 10.

The vehicle control device 10 acquires the information from the sensors described above, and controls an amount of fuel to be supplied to a cylinder in the engine 1 and the gear stage of the transmission 2 based on the acquired information. In a case where the vehicle V is in the automatic cruise mode, the vehicle control device 10 controls the engine 1 and the transmission 2 so that the vehicle V travels while maintaining the set speed. In a case where a speed limit device (SLD) (not shown) of the vehicle V is operating, the vehicle control device 10 controls the engine 1 and the transmission 2 so that the speed of the vehicle V does not exceed a set upper limit speed.

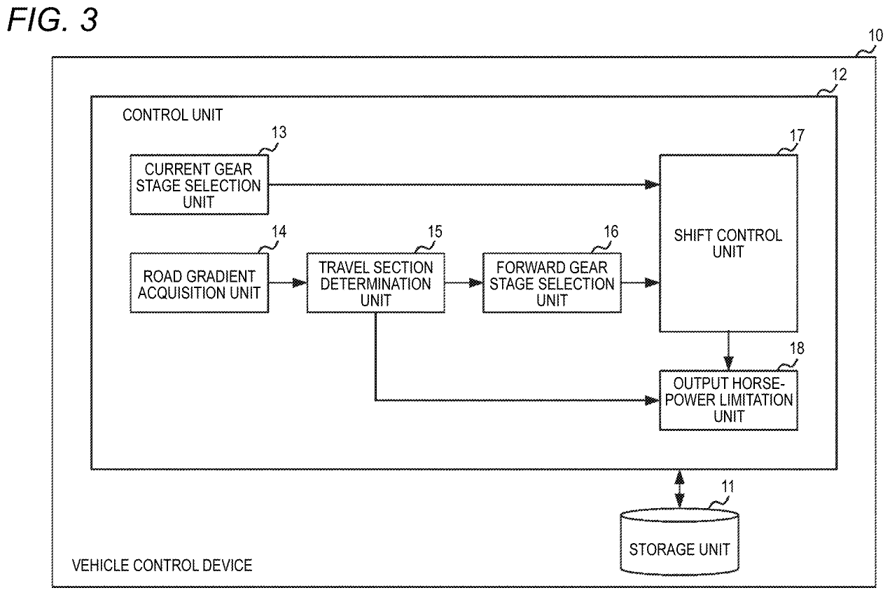

FIG. 3 is a diagram schematically showing a functional configuration of the vehicle control device 10 according to the embodiment. The vehicle control device 10 according to the embodiment includes a storage unit 11 and a control unit 12.

The storage unit 11 is, for example, a read only memory (ROM) or a random access memory (RAM). The storage unit 11 stores various programs for causing the control unit 12 to function. The storage unit 11 may store map information, and may store information indicating the road gradient of the road.

The control unit 12 is a calculation resource including a processor such as a central processing unit (CPU) (not shown). The control unit 12 implements functions of a current gear stage selection unit 13, a road gradient acquisition unit 14, a travel section determination unit 15, a forward gear stage selection unit 16, a shift control unit 17 by executing programs stored in the storage unit 11, and a horsepower limitation unit 18.

The current gear stage selection unit 13 selects a current gear stage, which is the gear stage of the transmission 2 in a section in which the vehicle V is currently traveling, based on an estimated value of a travel resistance of the vehicle V on the road on which the vehicle V is traveling. The travel resistance is calculated based on a rolling resistance of the drive wheel of the vehicle V, an air resistance of the vehicle V, and a gradient resistance.

Here, the current gear stage selection unit 13 calculates the travel resistance based on, for example, a driving force calculated by using a torque of the engine 1, the speed of the vehicle V measured by the speed sensor 5, and the total weight of the vehicle V acquired by the weight sensor 4, but is not limited thereto. The current gear stage selection unit 13 may calculate the travel resistance based on the road gradient on the road on which the vehicle V is currently traveling, which is acquired by the road gradient acquisition unit 14, and the total weight of the vehicle V acquired by the weight sensor 4.

Subsequently, the current gear stage selection unit 13 estimates the current travel resistance horsepower based on the calculated travel resistance and the speed of the vehicle V measured by the speed sensor 5. Subsequently, the current gear stage selection unit 13 selects the current gear stage by referring to a travel performance diagram of the vehicle V, so that the driving force of the vehicle V at the current speed of the vehicle V is larger than the travel resistance of the vehicle V in a current travel state.

The road gradient acquisition unit 14 acquires the road gradient on the road on which a vehicle is currently traveling. For example, based on the information indicating the position of the vehicle V acquired from the GPS sensor 3 and the map information stored in the storage unit 11, the road gradient acquisition unit 14 acquires the road gradient on the road on which the vehicle V is currently traveling.

The travel section determination unit 15 determines the forward travel section, which is ahead in a travel direction of the vehicle and is a travel section having a different road gradient from the current travel section in which the vehicle is currently traveling. The travel section determination unit 15 determines the forward travel section based on, for example, the road gradient acquired by the road gradient acquisition unit 14, such that the road gradient is substantially constant.

The forward gear stage selection unit 16 selects a forward gear stage, which is a gear stage of the vehicle in the forward travel section. The forward gear stage selection unit 16 selects the forward gear stage, which is a gear stage of the transmission 2 in the forward travel section, based on, for example, the road gradient of the forward travel section and the speed of the vehicle V. Specifically, first, the forward gear stage selection unit 16 estimates the travel resistance of the vehicle V in the forward travel section based on the road gradient in the forward travel section, the speed of the vehicle V, and the weight of the vehicle V. The forward gear stage selection unit 16 selects the forward gear stage by referring to the travel performance diagram of the vehicle V, so that the driving force of the vehicle V at the current speed of the vehicle V is larger than the travel resistance of the vehicle V in the forward travel section.

The shift control unit 17 controls shift of the gear stage of the transmission 2 based on the current gear stage selected by the current gear stage selection unit 13 and the forward gear stage selected by the forward gear stage selection unit 16. For example, in a case where the forward travel section is an uphill road on which the speed of the vehicle V decreases when the vehicle V travels at the current gear stage, the shift control unit 17 performs shift control to the current gear stage when the vehicle V is traveling in the current travel section, and performs shift control to the forward gear stage at the time of entering the forward travel section.

In this way, when the shift control unit 17 performs upshift from the current gear stage to the target gear stage and immediately performs downshift to the forward gear stage, shift change is performed frequently, and thus the driver may experience a sense of discomfort. Therefore, the shift control unit 17 controls shift so as not to perform shift change frequently. Specifically, in a case where the current gear stage selection unit 13 newly selects a target gear stage that is higher than the forward gear stage while the vehicle V is traveling in the current travel section at the current gear stage, the shift control unit 17 controls shift of the gear stage of the transmission 2 such that upshift from the current gear stage to the target gear position is prevented and the current gear stage is maintained.

The shift control unit 17 may prevent upshift based on a travel distance or a travel time from a position during the current travel in the current travel section to the end point of the current travel section. Specifically, in a case where the travel distance is equal to or smaller than a predetermined travel distance or equal to or smaller than a predetermined travel time, the shift control unit 17 prevents upshift.

Here, the “predetermined travel distance” is an “upshift determination reference threshold distance” referred to by the shift control unit 17 in order to determine whether or not to perform upshift of the gear stage of the transmission 2 from the current gear stage to the target gear stage in the current travel section. A specific value of the upshift determination reference threshold distance may be determined via experiment in consideration of the gradient information of the road on which the vehicle V is assumed to travel, performance of the engine 1 provided in the vehicle V, and the like, and is, for example, 1.5 kilometers. This is a distance in which the vehicle V traveling at 90 kilometers per hour travels in one minute. As a result, the shift control unit 17 can prevent the driver of the vehicle V from having a shift busy feeling due to repetition of gear shift in a short time. The upshift determination reference threshold distance is stored in the storage unit 11.

Here, the “predetermined travel time” is an “upshift determination reference threshold time” referred to by the shift control unit 17 in order to determine whether or not to perform upshift of the gear stage of the transmission 2 from the current gear stage to the target gear stage in the current travel section. A specific value of the upshift determination reference threshold time may be determined via experiment in consideration of the gradient information of the road on which the vehicle V is assumed to travel, performance of the engine 1 provided in the vehicle V, and the like, and is, for example, 1 minute. As a result, the shift control unit 17 can prevent the driver of the vehicle V from having a shift busy feeling due to repetition of gear shift in a short time. The upshift determination reference threshold distance is stored in the storage unit 11.

The horsepower limitation unit 18 controls the output horsepower of the engine 1 by controlling a fuel injection amount with respect to the engine 1. For example, the horsepower limitation unit 18 limits the output horsepower of the engine in order to prevent the driver operating the vehicle V unnecessarily accelerates and the horsepower of the engine is output unnecessarily, thereby preventing deterioration of the fuel efficiency. For example, the horsepower limitation unit 18 limits the output horsepower of the engine 1 based on the travel resistance of the vehicle. Specifically, the horsepower limitation unit 18 limits the output horsepower of the engine 1 such that a predetermined marginal horsepower is included with respect to the travel resistance horsepower.

The horsepower limitation unit 18 may release the output horsepower limitation of the engine 1 even when the output horsepower limitation of the engine 1 is being performed. For example, the horsepower limitation unit 18 releases the output horsepower limitation of the engine 1 at the time of entering the forward travel section. Specifically, the horsepower limitation unit 18 releases the output horsepower limitation of the engine 1 in a case where the vehicle enters a predetermined range including a border between the current travel section and the forward travel section. In this way, the horsepower limitation unit 18 can prevent decrease in the marginal horsepower of the vehicle due to delay in a release timing of the output horsepower limitation of the engine 1 in a case where, for example, the forward travel section is a steep uphill slope. Therefore, the horsepower limitation unit 18 can reduce the feeling of discomfort of the driver and enhance the drive feeling.

Here, the “predetermined range” is a “horsepower limitation release range” referred to by the horsepower limitation unit 18 in order to determine whether or not to release the output horsepower limitation of the engine 1. A specific value of the horsepower limitation release range may be determined via experiment in consideration of the gradient information of the road on which the vehicle V is assumed to travel, performance of the engine 1 provided in the vehicle V. For example, the horsepower limitation release range is from a position of a rear end of the vehicle V at a time when a front end of the vehicle V reaches the border between the current travel section and the forward travel section, to a position of the front end of the vehicle V at the time when the rear end of the vehicle V reaches the border between the current travel section and the forward travel section. More specifically, the horsepower limitation release range is a range from a position shifted by 10 m to the current travel section side to a position shifted by 10 m to the forward travel section side from the border position between the current travel section and the forward travel section.

The horsepower limitation unit 18 may release the output horsepower limitation of the engine 1 in a case where a predetermined condition is satisfied even when the output horsepower limitation of the engine 1 is being performed. Hereinafter, a specific condition for the horsepower limitation unit 18 to release the output horsepower limitation of the engine 1 will be described. In the following description, it is assumed that the vehicle V travels in a gear stage of the eleventh stage in the current travel section, but the gear stage is not particularly limited.

(Processing for the Horsepower Limitation Unit 18 to Cancel Horsepower Limitation)

In a case where the vehicle V travels in a section where the travel resistance of the vehicle V increases such as an uphill road, for example, when the vehicle V travels in the forward travel section in a state in which the output horsepower of the engine 1 is limited, the marginal horsepower of the vehicle V decreases. Therefore, the horsepower limitation unit 18 releases the output horsepower limitation of the engine 1 in a case where the travel resistance in the forward travel section is greater than the travel resistance of the vehicle in the current travel section. In this way, the horsepower limitation unit 18 can prevent decrease in the marginal horsepower of the vehicle. Hereinafter, the processing for the horsepower limitation unit 18 to release limitation of the output horsepower of the engine 1 based on the travel resistance of the forward travel section will be specifically described. In the following description, it is assumed that the road gradient acquisition unit 14 has acquired the road gradient of the forward travel section, and the travel section determination unit 15 has estimated the travel resistance of the forward travel section.

(A Case where Upshift is Prevented)

The horsepower limitation unit 18 releases the output horsepower limitation of the engine 1 in a state in which the shift control unit 17 prevents upshift of the gear stage. In the case where the shift control unit 17 prevents upshift, since the travel resistance is assumed to increase in the forward traveling section, the horsepower limitation unit 18 can prevent decrease in the marginal horsepower by releasing the output horsepower limitation of the engine 1 in advance, thereby preventing decrease in the speed of the vehicle V. Therefore, the horsepower limitation unit 18 can reduce the feeling of discomfort given to the driver.

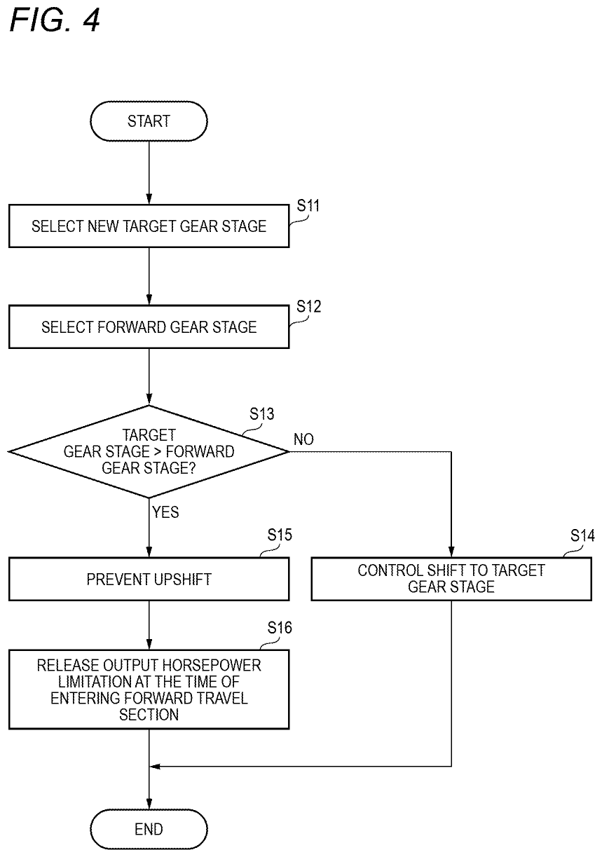

FIG. 4 is a flowchart of a processing of releasing limitation of the output horsepower of the engine 1 in a state in which upshift is prevented. In the explanation of the flowchart of FIG. 4, the horsepower limitation unit 18 determines that the travel resistance of the current travel section is equal to or smaller than a predetermined value, and limits the output horsepower of the engine 1.

First, the current gear stage selection unit 13 selects a new target gear stage (S11). Subsequently, the forward gear stage selection unit 16 selects the forward gear stage (S12). Then, the shift control unit 17 determines whether or not the target gear stage is a gear stage higher than the forward gear stage (S13).

In a case where the shift control unit 17 determines that the target gear stage is a gear stage the same as or lower than the forward gear stage (No in S13), the shift control unit 17 controls shift of the gear stage of the transmission 2 to be the target gear stage (S14). Specifically, in a case where the target gear stage is the gear stage of the twelfth stage, which is the same as the forward gear stage, the shift control unit 17 controls shift of the gear stage of the transmission 2 so as to upshift from the eleventh stage, which is the current gear stage, to the twelfth stage, which is the target gear stage, and in a case where the target gear stage is the gear stage of the tenth stage, which is lower than the forward gear stage, the shift control unit 17 controls shift of the gear stage of the transmission 2 so as to downshift from the current gear stage to the tenth stage, which is the target gear stage.

In a case where the shift control unit 17 determines that the target gear stage is a gear stage higher than the forward gear stage (Yes in S13), the shift control unit 17 controls shift so as to prevent upshift and to maintain the current gear stage (S15). Specifically, in a case where the shift control unit 17 determines that the target gear stage is the gear stage of the twelfth stage, which is higher than the eleventh stage as the forward gear stage, the shift control unit 17 maintains the eleventh stage as the current gear stage. The horsepower limitation unit 18 releases the output horsepower limitation of the engine 1 at the time of entering the forward travel section (S16).

(A Case of Downshift)

In a case where the shift control unit 17 controls shift so as to perform downshift to the forward gear stage, the horsepower limitation unit 18 releases the output horsepower limitation of the engine. Specifically, in a case where the shift control unit 17 determines that the forward gear stage is lower by two or more stages than the current gear stage and performs downshift from the current gear stage to the forward gear stage, the horsepower limitation unit 18 releases the output horsepower limitation of the engine. In the case where the shift control unit 17 has performed downshift, the travel resistance is assumed to increase in the forward traveling section. Therefore, the horsepower limitation unit 18 releases the output horsepower limitation of the engine 1 in advance. In this way, the horsepower limitation unit 18 can prevent decrease in the marginal horsepower of the vehicle, and thus can prevent the speed of the vehicle V from decreasing. Therefore, the horsepower limitation unit 18 can reduce the feeling of discomfort given to the driver.

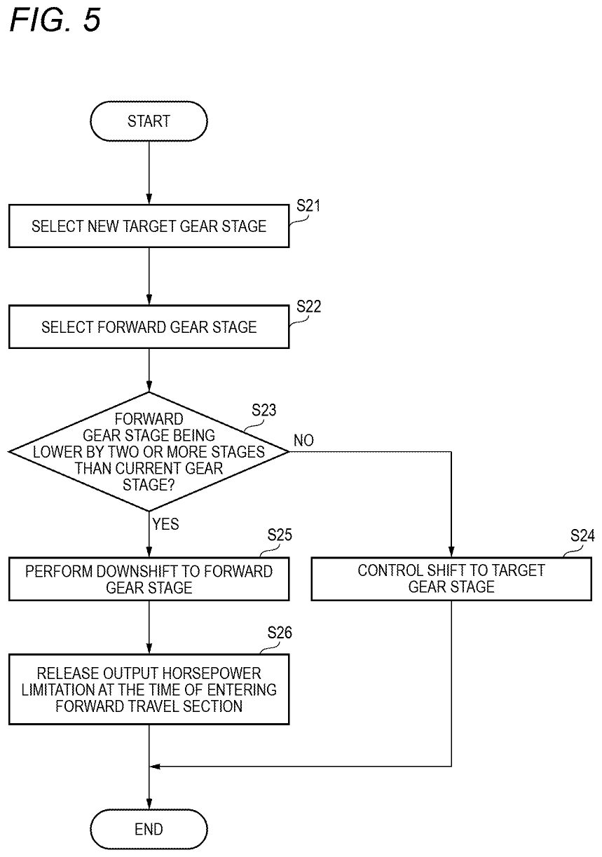

FIG. 5 is a flowchart of a processing of releasing the output limitation of the engine 1 in a case where downshift is performed when entering the forward section. First, the current gear stage selection unit 13 selects a new target gear stage (S21). Subsequently, the forward gear stage selection unit 16 selects the forward gear stage (S22).

The shift control unit 17 determines whether or not the forward gear stage selected by the forward gear stage selection unit 16 is lower by two or more stages than the current gear stage (S23). In a case where the shift control unit 17 determines that the forward gear stage is one stage lower than, the same as, or higher than the target gear stage (No in S23), the shift control unit 17 controls shift of the gear stage of the transmission 2 to be the target gear stage (S24). In a case where the shift control unit 17 determines that the forward gear stage is lower by two or more stages than the current gear stage (Yes in S23), the shift control unit 17 performs shift control so as to perform downshift to the forward gear stage (S26). Specifically, in a case where the shift control unit 17 determines that the forward gear stage is lower by two or more stages than the current gear stage, the horsepower limitation unit 18 releases the output horsepower limitation of the engine 1 at the time of entering the forward travel section (S26).

[Effect of the Embodiment]

As described above, the horsepower limitation unit 18 limits the output horsepower of the engine 1 based on the travel resistance of the current travel section, and releases the limitation of the output horsepower of the engine 1 based on the travel resistance of the forward travel section. In this way, the horsepower limitation unit 18 can prevent decrease in the marginal horsepower of the vehicle in a case of traveling in a state where the travel resistance in the forward travel section increases and the output horsepower of the engine 1 increases, thereby reducing the discomfort of the driver and enhancing the drive feeling.

Although the present disclosure has been described using embodiments, the technical scope of the present disclosure is not limited to the scope described in the above embodiment, and various modifications and changes can be made without departing from the scope thereof. For example, a specific embodiment of distributing and integrating devices is not limited to the above embodiment, and all or a part thereof may be configured to be functionally or physically distributed and integrated in arbitrary units. New embodiments generated from any combination of a plurality of embodiments are also included in embodiments of the present disclosure. Effects of the new embodiments generated from the combinations include effects of the original embodiments.

The present application is based on Japanese Patent Application No. 2017-095971 filed on May 12, 2017, contents of which are incorporated herein as reference.

### INDUSTRIAL APPLICABILITY

The vehicle control device of the present disclosure is useful in being capable of reducing an uncomfortable feeling of a driver.

### REFERENCE SIGNS LIST

1 Engine
2 Transmission
3 GPS sensor
4 Weight sensor
5 Speed sensor
6 Accelerator opening degree sensor
10 Vehicle control device
11 storage unit
12 control unit
13 Current gear stage selection unit
14 Road gradient acquisition unit
15 Travel section determination unit
16 Forward gear stage selection unit
17 Shift control unit
18 Horsepower limitation unit

1. A vehicle control device comprising:
a road gradient acquisition unit configured to acquire a road gradient of a road on which a vehicle is currently traveling;
a travel section determination unit configured to determine a forward travel section that is a travel section having a different road gradient from a current travel section in which the vehicle is currently traveling and that is ahead in a travel direction of the vehicle; and
a horsepower limitation unit configured to perform an output horsepower limitation that limits an output horsepower of an engine based on a travel resistance of the vehicle,
wherein the horsepower limitation unit is configured to release the output horsepower limitation of the engine in a case where the travel resistance in the forward travel section is greater than the travel resistance of the vehicle in the current travel section.

2. The vehicle control device according to claim 1,
wherein the horsepower limitation unit is configured to release the output horsepower limitation of the engine based on the travel resistance of the vehicle estimated using a road gradient of the forward travel section.

3. The vehicle control device according to claim 1, further comprising:
a current gear stage selection unit configured to select a current gear stage, which is a gear stage in the current travel section, based on the travel resistance;
a forward gear stage selection unit configured to select a forward gear stage, which is a gear stage of the vehicle in the forward travel section; and
a shift control unit configured to control shift so as to prevent upshift and to maintain the current gear stage in a case where the current gear stage selection unit newly selects a target gear stage higher than the forward gear stage while the vehicle is traveling in the current travel section at the current gear stage,
wherein the horsepower limitation unit is configured to release the output horsepower limitation of the engine in a state where the shift control unit is preventing the upshift of the gear stage.

4. The vehicle control device according to claim 3,
wherein the shift control unit is configured to perform downshift from the current gear stage to the selected forward gear stage in a case where the forward gear stage is lower by two or more stages than the current gear state, and
wherein the horsepower limitation unit is configured to release the output horsepower limitation of the engine in a case where the shift control unit controls shift so as to perform the downshift to the forward gear stage lower by two or more stages than the current gear state.

5. The vehicle control device according to claim 1,
wherein the horsepower limitation unit is configured to release the output horsepower limitation of the engine in a case where the vehicle enters a predetermined range including a border between the current travel section and the forward travel section.
